(19) United States
(12) Patent Application Publication
(10) Pub. No.: US 2025/0016744 A1
(43) Pub. Date: Jan. 9, 2025

(54) METHODS AND APPARATUS OF DETERMINING FORMAT OF UPLINK AND DOWNLINK TRANSMISSIONS FOR FULL DUPLEX TIME DIVISION DUPLEX

(71) Applicant: Lenovo (Beijing) Limited, Beijing (CN)

(72) Inventors: Yuantao Zhang, Beijing (CN); Ruixiang Ma, Beijing (CN); Hongmei Liu, Beijing (CN); Yingying Li, Beijing (CN); Haiming Wang, Beijing (CN)

(73) Assignee: Lenovo (Beijing) Limited, Beijing (CN)

(21) Appl. No.: 18/718,760

(22) PCT Filed: Dec. 10, 2021
(86) PCT No.: PCT/CN2021/137173

§ 371 Date: Jun. 11, 2024

(51) Int. Cl. H04W 72/044; H04L 5/14

(52) U.S. Cl. CPC H04W 72/044; H04L 5/14

(57) ABSTRACT

Methods and apparatus of determining format of uplink and downlink transmissions for full duplex time division duplex are disclosed. The method includes: receiving, by a receiver, a first set of Time Division Duplex (TDD) configurations of uplink (UL) and downlink (DL) transmissions for a first set of Bandwidth Parts (BWPs), and a second set of TDD configurations of UL and DL transmissions for a second set of BWPs; and determining, by a processor, a resulting format of UL and DL transmissions based on the first set of TDD configurations and the second set of TDD configurations.

### FIELD

The subject matter disclosed herein relates generally to wireless communication and more particularly relates to, but not limited to, methods and apparatus of determining format of uplink and downlink transmissions for full duplex time division duplex.

### BACKGROUND

The following abbreviations and acronyms are herewith defined, at least some of which are referred to within the specification:

Third Generation Partnership Project (3GPP), 5th Generation (5G), New Radio (NR), 5G Node B (gNB), Long Term Evolution (LTE), LTE Advanced (LTE-A), E-UTRAN Node B (eNB), Universal Mobile Telecommunications System (UMTS), Worldwide Interoperability for Microwave Access (WiMAX), Evolved UMTS Terrestrial Radio Access Network (E-UTRAN), Wireless Local Area Networking (WLAN), Orthogonal Frequency Division Multiplexing (OFDM), Single-Carrier Frequency-Division Multiple Access (SC-FDMA), Downlink (DL), Uplink (UL), User Equipment (UE), Network Equipment (NE), Radio Access Technology (RAT), Receive or Receiver (RX), Transmit or Transmitter (TX), Physical Downlink Control Channel (PDCCH), Physical Uplink Control Channel (PUCCH), Physical Uplink Shared Channel (PUSCH), Physical Random Access Channel (PRACH), Bandwidth Part (BWP), Downlink Control Information (DCI), Frequency Division Duplexing (FDD), Frequency Division Multiple Access (FDMA), Physical Layer (PHY), Radio Frequency (RF), Radio Resource Control (RRC), Sounding Reference Signal (SRS), Time-Division Duplexing (TDD), Transmission and Reception Point (TRP), Base Station (BS), Full Duplex (FD), Half Duplex (HD), Full Duplex Frequency-Division Duplex (FD-FDD), Half Duplex Frequency-Division Duplex (HD-FDD).

In wireless communication, such as a Third Generation Partnership Project (3GPP) mobile network, a wireless mobile network may provide a seamless wireless communication service to a wireless communication terminal having mobility, i.e., user equipment (UE). The wireless mobile network may be formed of a plurality of base stations and a base station may perform wireless communication with the UEs.

In a wireless communication system, the term “duplex” means bidirectional communication between two devices, where the transmissions over the link in each direction may take place at the same time (i.e., full duplex, or FD) or mutual exclusive time (i.e., half duplex, or HD).

### SUMMARY

Methods and apparatus of determining format of uplink and downlink transmissions for full duplex time division duplex are disclosed.

According to a first aspect, there is provided a method, including: receiving, by a receiver, a first set of Time Division Duplex (TDD) configurations of uplink (UL) and downlink (DL) transmissions for a first set of Bandwidth Parts (BWPs), and a second set of TDD configurations of UL and DL transmissions for a second set of BWPs; and determining, by a processor, a resulting format of UL and DL transmissions based on the first set of TDD configurations and the second set of TDD configurations.

According to a second aspect, there is provided a method, including: transmitting, by a transmitter, a first set of Time Division Duplex (TDD) configurations of uplink (UL) and downlink (DL) transmissions for a first set of Bandwidth Parts (BWPs), and a second set of TDD configurations of UL and DL transmissions for a second set of BWPs; and determining, by a processor, a resulting format of UL and DL transmissions for a user device based on the first set of TDD configurations, the second set of TDD configurations, and a capability reporting from the user device.

According to a third aspect, there is provided an apparatus, including: a receiver that receives a first set of Time Division Duplex (TDD) configurations of uplink (UL) and downlink (DL) transmissions for a first set of Bandwidth Parts (BWPs), and a second set of TDD configurations of UL and DL transmissions for a second set of BWPs; and a processor that determines a resulting format of UL and DL transmissions based on the first set of TDD configurations and the second set of TDD configurations.

According to a fourth aspect, there is provided an apparatus, including: a transmitter that transmits a first set of Time Division Duplex (TDD) configurations of uplink (UL) and downlink (DL) transmissions for a first set of Bandwidth Parts (BWPs), and a second set of TDD configurations of UL and DL transmissions for a second set of BWPs; and a processor that determines a resulting format of UL and DL transmissions for a user device based on the first set of TDD configurations, the second set of TDD configurations, and a capability reporting from the user device.

### BRIEF DESCRIPTION OF THE DRAWINGS

A more particular description of the embodiments will be rendered by reference to specific embodiments illustrated in the appended drawings. Given that these drawings depict only some embodiments and are not therefore considered to be limiting in scope, the embodiments will be described and explained with additional specificity and details through the use of the accompanying drawings, in which:

FIG. 1 is a schematic diagram illustrating a wireless communication system in accordance with some implementations of the present disclosure;

FIG. 2 is a schematic block diagram illustrating components of user equipment (UE) in accordance with some implementations of the present disclosure;

FIG. 3 is a schematic block diagram illustrating components of network equipment (NE) in accordance with some implementations of the present disclosure;

FIG. 4A is a schematic diagram illustrating examples of existing duplex modes in wireless communication systems in accordance with some implementations of the present disclosure;

FIG. 4B is a schematic diagram illustrating examples of new duplex modes in wireless communication systems in accordance with some implementations of the present disclosure;

FIG. 5 is a schematic diagram illustrating an example of UL/DL configuration by tdd-UL-DL-ConfigCommon in accordance with some implementations of the present disclosure;

FIG. 6A is a schematic diagram illustrating an example where tdd-UL-DL-ConfigCommon-AddBWP overrides tdd-UL-DL-ConfigCommon for a DL slot and a flexible slot in accordance with some implementations of the present disclosure;

FIG. 6B is a schematic diagram illustrating an example of an associated additional UL BWP with respect to a UL active BWP for the uplink transmissions of FIG. 6A in accordance with some implementations of the present disclosure;

FIG. 7 is a schematic diagram illustrating an example where tdd-UL-DL-ConfigCommon-AddBWP overrides tdd-UL-DL-ConfigCommon for two DL slots and a flexible slot, and tdd-UL-DL-ConfigDedicated-AddBWP overrides tdd-UL-DL-ConfigCommon-AddBWP for one flexible slot, in accordance with some implementations of the present disclosure;

FIG. 8 is a schematic diagram illustrating an example where tdd-UL-DL-ConfigDedicated-AddBWP overrides tdd-UL-DL-ConfigDedicated for one DL slot and one flexible slot in accordance with some implementations of the present disclosure;

FIG. 9 is a flow chart illustrating steps of determining format of uplink and downlink transmissions for full duplex time division duplex by UE in accordance with some implementations of the present disclosure; and

FIG. 10 is a flow chart illustrating steps of determining format of uplink and downlink transmissions for full duplex time division duplex by gNB or NE in accordance with some implementations of the present disclosure.

### DETAILED DESCRIPTION

As will be appreciated by one skilled in the art, aspects of the embodiments may be embodied as a system, an apparatus, a method, or a program product. Accordingly, embodiments may take the form of an all-hardware embodiment, an all-software embodiment (including firmware, resident software, micro-code, etc.) or an embodiment combining software and hardware aspects.

Furthermore, one or more embodiments may take the form of a program product embodied in one or more computer readable storage devices storing machine readable code, computer readable code, and/or program code, referred to hereafter as “code.” The storage devices may be tangible, non-transitory, and/or non-transmission.

Reference throughout this specification to “one embodiment,” “an embodiment,” “an example,” “some embodiments,” “some examples,” or similar language means that a particular feature, structure, or characteristic described is included in at least one embodiment or example. Thus, instances of the phrases “in one embodiment,” “in an example,” “in some embodiments,” and similar language throughout this specification may, but do not necessarily, all refer to the same embodiment(s). It may or may not include all the embodiments disclosed. Features, structures, elements, or characteristics described in connection with one or some embodiments are also applicable to other embodiments, unless expressly specified otherwise. The terms “including,” “comprising,” “having,” and variations thereof mean “including but not limited to,” unless expressly specified otherwise.

An enumerated listing of items does not imply that any or all of the items are mutually exclusive, unless expressly specified otherwise. The terms “a,” “an,” and “the” also refer to “one or more” unless expressly specified otherwise.

Throughout the disclosure, the terms “first,” “second,” “third,” and etc. are all used as nomenclature only for references to relevant devices, components, procedural steps, and etc. without implying any spatial or chronological orders, unless expressly specified otherwise. For example, a “first device” and a “second device” may refer to two separately formed devices, or two parts or components of the same device. In some cases, for example, a “first device” and a “second device” may be identical, and may be named arbitrarily. Similarly, a “first step” of a method or process may be carried or performed after, or simultaneously with, a “second step.”

It should be understood that the term “and/or” as used herein refers to and includes any and all possible combinations of one or more of the associated listed items. For example, “A and/or B” may refer to any one of the following three combinations: existence of A only, existence of B only, and co-existence of both A and B. The character “/” generally indicates an “or” relationship of the associated items. This, however, may also include an “and” relationship of the associated items. For example, “A/B” means “A or B,” which may also include the co-existence of both A and B, unless the context indicates otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of various embodiments are described below with reference to schematic flowchart diagrams and/or schematic block diagrams of methods, apparatuses, systems, and program products. It will be understood that each block of the schematic flowchart diagrams and/or schematic block diagrams, as well as combinations of blocks in the schematic flowchart diagrams and/or schematic block diagrams, may be implemented by code. This code may be provided to a processor of a general-purpose computer, special purpose computer, or other programmable data processing apparatus to produce a machine, such that the instructions executed via the processor of the computer or other programmable data processing apparatus create a means for implementing the functions or acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function or act specified in the schematic flowchart diagrams and/or schematic block diagrams.

The schematic flowchart diagrams and/or schematic block diagrams in the Figures illustrate the architecture, functionality, and operation of possible implementations of different apparatuses, systems, methods, and program products according to various embodiments. In this regard, each block in the schematic flowchart diagrams and/or schematic block diagrams may represent a module, segment, or portion of code, which includes one or more executable instructions of the code for implementing the specified logical function(s). One skilled in the relevant art will recognize, however, that the flowchart diagrams need not necessarily be practiced in the sequence shown and are able to be practiced without one or more of the specific steps, or with other steps not shown.

It should also be noted that, in some alternative implementations, the functions noted in the identified blocks may occur out of the order noted in the Figures. For example, two blocks shown in succession may, in fact, be substantially executed in concurrence, or the blocks may sometimes be executed in reverse order, depending upon the functionality involved.

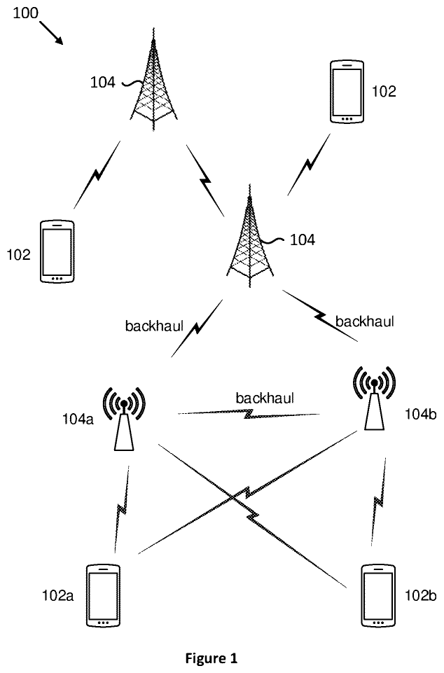

FIG. 1 is a schematic diagram illustrating a wireless communication system. It depicts an embodiment of a wireless communication system 100. In one embodiment, the wireless communication system 100 may include a user equipment (UE) 102 and a network equipment (NE) 104. Even though a specific number of UEs 102 and NEs 104 is depicted in FIG. 1, one skilled in the art will recognize that any number of UEs 102 and NEs 104 may be included in the wireless communication system 100.

The UEs 102 may be referred to as remote devices, remote units, subscriber units, mobiles, mobile stations, users, terminals, mobile terminals, fixed terminals, subscriber stations, user terminals, apparatus, devices, user device, or by other terminology used in the art.

In one embodiment, the UEs 102 may be autonomous sensor devices, alarm devices, actuator devices, remote control devices, or the like. In some other embodiments, the UEs 102 may include computing devices, such as desktop computers, laptop computers, personal digital assistants (PDAs), tablet computers, smart phones, smart televisions (e.g., televisions connected to the Internet), set-top boxes, game consoles, security systems (including security cameras), vehicle on-board computers, network devices (e.g., routers, switches, modems), or the like. In some embodiments, the UEs 102 include wearable devices, such as smart watches, fitness bands, optical head-mounted displays, or the like. The UEs 102 may communicate directly with one or more of the NEs 104.

The NE 104 may also be referred to as a base station, an access point, an access terminal, a base, a Node-B, an eNB, a gNB, a Home Node-B, a relay node, an apparatus, a device, or by any other terminology used in the art. Throughout this specification, a reference to a base station may refer to any one of the above referenced types of the network equipment 104, such as the eNB and the gNB.

The NEs 104 may be distributed over a geographic region. The NE 104 is generally part of a radio access network that includes one or more controllers communicably coupled to one or more corresponding NEs 104. The radio access network is generally communicably coupled to one or more core networks, which may be coupled to other networks, like the Internet and public switched telephone networks. These and other elements of radio access and core networks are not illustrated, but are well known generally by those having ordinary skill in the art.

In one implementation, the wireless communication system 100 is compliant with a 3GPP 5G new radio (NR). In some implementations, the wireless communication system 100 is compliant with a 3GPP protocol, where the NEs 104 transmit using an OFDM modulation scheme on the DL and the UEs 102 transmit on the uplink (UL) using a SC-FDMA scheme or an OFDM scheme. More generally, however, the wireless communication system 100 may implement some other open or proprietary communication protocols, for example, WiMAX. The present disclosure is not intended to be limited to the implementation of any particular wireless communication system architecture or protocol.

The NE 104 may serve a number of UEs 102 within a serving area, for example, a cell (or a cell sector) or more cells via a wireless communication link. The NE 104 transmits DL communication signals to serve the UEs 102 in the time, frequency, and/or spatial domain.

Communication links are provided between the NE 104 and the UEs 102a, 102b, 102c, and 102d, which may be NR UL or DL communication links, for example. Some UEs 102 may simultaneously communicate with different Radio Access Technologies (RATs), such as NR and LTE. Direct or indirect communication link between two or more NEs 104 may be provided.

The NE 104 may also include one or more transmit receive points (TRPs) 104a. In some embodiments, the network equipment may be a gNB 104 that controls a number of TRPs 104a. In addition, there is a backhaul between two TRPs 104a. In some other embodiments, the network equipment may be a TRP 104a that is controlled by a gNB.

Communication links are provided between the NEs 104, 104a and the UEs 102, 102a, respectively, which, for example, may be NR UL/DL communication links. Some UEs 102, 102a may simultaneously communicate with different Radio Access Technologies (RATs), such as NR and LTE.

In some embodiments, the UE 102a may be able to communicate with two or more TRPs 104a that utilize a non-ideal backhaul, simultaneously. A TRP may be a transmission point of a gNB. Multiple beams may be used by the UE and/or TRP(s). The two or more TRPs may be TRPs of different gNBs, or a same gNB. That is, different TRPs may have the same Cell-ID or different Cell-IDs. The terms “TRP” and “transmitting-receiving identity” may be used interchangeably throughout the disclosure.

The technology disclosed, or at least some of the examples, may be applicable to scenarios with multiple TRPs or without multiple TRPs, as long as multiple PDCCH transmissions are supported.

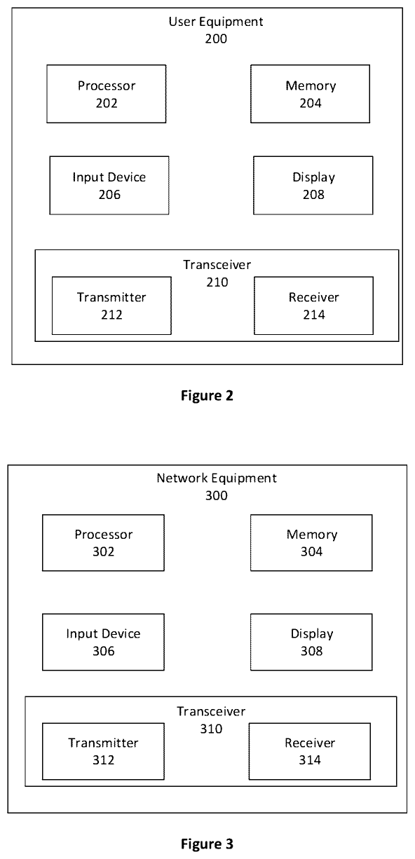

FIG. 2 is a schematic block diagram illustrating components of user equipment (UE) according to one embodiment. A UE 200 may include a processor 202, a memory 204, an input device 206, a display 208, and a transceiver 210. In some embodiments, the input device 206 and the display 208 are combined into a single device, such as a touchscreen. In certain embodiments, the UE 200 may not include any input device 206 and/or display 208. In various embodiments, the UE 200 may include one or more processors 202 and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (CPU), a graphics processing unit (GPU), an auxiliary processing unit, a field programmable gate array (FPGA), or similar programmable controller. In some embodiments, the processor 202 executes instructions stored in the memory 204 to perform the methods and routines described herein. The processor 202 is communicatively coupled to the memory 204 and the transceiver 210.

The memory 204, in one embodiment, is a computer readable storage medium. In some embodiments, the memory 204 includes volatile computer storage media. For example, the memory 204 may include a RAM, including dynamic RAM (DRAM), synchronous dynamic RAM (SDRAM), and/or static RAM (SRAM). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 stores data relating to trigger conditions for transmitting the measurement report to the network equipment. In some embodiments, the memory 204 also stores program code and related data.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display.

The display 208, in one embodiment, may include any known electronically controllable display or display device. The display 208 may be designed to output visual, audio, and/or haptic signals.

The transceiver 210, in one embodiment, is configured to communicate wirelessly with the network equipment. In certain embodiments, the transceiver 210 comprises a transmitter 212 and a receiver 214. The transmitter 212 is used to transmit UL communication signals to the network equipment and the receiver 214 is used to receive DL communication signals from the network equipment.

The transmitter 212 and the receiver 214 may be any suitable type of transmitters and receivers. Although only one transmitter 212 and one receiver 214 are illustrated, the transceiver 210 may have any suitable number of transmitters 212 and receivers 214. For example, in some embodiments, the UE 200 includes a plurality of the transmitter 212 and the receiver 214 pairs for communicating on a plurality of wireless networks and/or radio frequency bands, with each of the transmitter 212 and the receiver 214 pairs configured to communicate on a different wireless network and/or radio frequency band.

FIG. 3 is a schematic block diagram illustrating components of network equipment (NE) 300 according to one embodiment. The NE 300 may include a processor 302, a memory 304, an input device 306, a display 308, and a transceiver 310. As may be appreciated, the processor 302, the memory 304, the input device 306, the display 308, and the transceiver 310 may be similar to the processor 202, the memory 204, the input device 206, the display 208, and the transceiver 210 of the UE 200, respectively.

In some embodiments, the processor 302 controls the transceiver 310 to transmit DL signals or data to the UE 200. The processor 302 may also control the transceiver 310 to receive UL signals or data from the UE 200. In another example, the processor 302 may control the transceiver 310 to transmit DL signals containing various configuration data to the UE 200.

In some embodiments, the transceiver 310 comprises a transmitter 312 and a receiver 314. The transmitter 312 is used to transmit DL communication signals to the UE 200 and the receiver 314 is used to receive UL communication signals from the UE 200.

The transceiver 310 may communicate simultaneously with a plurality of UEs 200. For example, the transmitter 312 may transmit DL communication signals to the UE 200. As another example, the receiver 314 may simultaneously receive UL communication signals from the UE 200. The transmitter 312 and the receiver 314 may be any suitable type of transmitters and receivers. Although only one transmitter 312 and one receiver 314 are illustrated, the transceiver 310 may have any suitable number of transmitters 312 and receivers 314. For example, the NE 300 may serve multiple cells and/or cell sectors, where the transceiver 310 includes a transmitter 312 and a receiver 314 for each cell or cell sector.

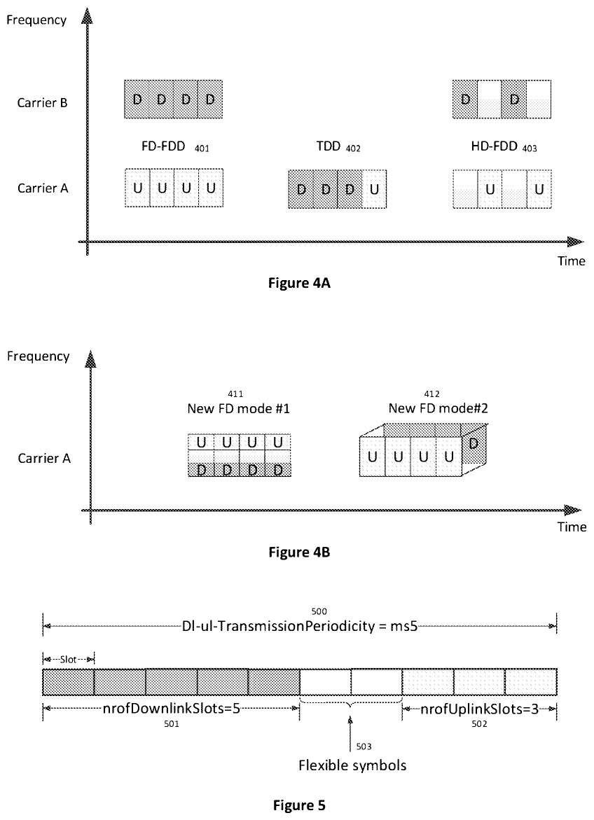

FIG. 4A is a schematic diagram illustrating examples of existing duplex modes in wireless communication systems in accordance with some implementations of the present disclosure. There are three duplex modes, namely: full duplex frequency division duplex (FD-FDD) 401, time division duplex (TDD) 402, and half duplex frequency division duplex (HD-FDD) 403, as shown in FIG. 4A. In FIG. 4A, D denotes downlink (DL), and U denotes uplink (UL).

In existing full duplex (FD) transceiver, different carrier frequencies are employed for each link direction, e.g. carrier A for UL transmission and carrier B for DL transmission. This is referred to as full duplex frequency division duplex (FD-FDD) 401.

In the case of half-duplex (HD) transceiver, the link directions are separated by time domain resources. When the same carrier frequency is used for each link direction, e.g. carrier A for both UL and DL transmissions, the HD transceiver is referred to as time division duplex (TDD) system 402. If different carrier frequencies are used, e.g. carrier A for UL transmission and carrier B for DL transmission, the system is known as half duplex FDD (HD-FDD) 403.

New full duplex modes enable simultaneous transmission and reception by the same device on the same carrier, which have the potential to increase the link throughput compared with that in the existing duplex modes. The transmission latency is also reduced because of bidirectional transmission in a time slot.

FIG. 4B is a schematic diagram illustrating examples of new duplex modes in wireless communication systems in accordance with some implementations of the present disclosure. In FIG. 4B, D denotes downlink (DL), and U denotes uplink (UL). Depending on whether overlapped DL/UL resource occupation (i.e., resources overlapping in both time and frequency domain) is allowed or not, there are two new full duplex (FD) modes, i.e.:
new FD mode #1 411, where the UL and DL occupy non-overlapped frequency resources in a same carrier, e.g. carrier A, and
new FD mode #2 412, where the UL and DL may occupy overlapped resources in the same carrier, e.g. carrier A.

For the new FD mode #1, the BS may allocate one set of UEs to use one set of frequency resources for UL, while allocate another set of UEs to occupy another set of frequency domain resources for DL, and the DL and UL resources are available simultaneously in the time domain in the same carrier, but are not overlapped in the frequency domain.

For the new FD mode #2, the BS may allocate one set of UEs to use one set of frequency resources for UL, while allocate another set of UEs to occupy same set of frequency domain resources for DL.

Simultaneous DL and UL in a same carrier will incur self-interference. Specifically, in the base station (BS) side, the DL transmission might contaminate UL reception; while in the UE side, the UL transmission might contaminate DL reception.

In the new FD mode #1, such self-interference level would be lower than that in the new FD mode #2 due to the non-overlapped DL and UL resources.

In addition, it would be relatively easier and feasible to realize full duplex in the base station (BS) side than in the UE side, given the fact that more room is typically available in the BS side, which enables separation of Tx/Rx antenna branches for interference cancellation. In addition, more complex and advanced transceiver may be deployed in the BS side, which may be necessary for self-interference cancellation.

The present disclosure is focused on the two new FD modes in the base station (BS) only, or in both UE side and BS side, and particularly UL performance enhancement in terms of more UL resources for lower latency UL transmission in the TDD system.

The UE may provide a capability reporting to the base station (BS), which may include an indication of whether the UE supports, and/or to what extent the UE supports, the full duplex operation in the BS side, or in UE side. The BS may accordingly determine an applicable format of UL and DL transmissions for each UE based on their respective capability reporting.

In some examples, the TDD slot format in 5G NR may include downlink symbols, uplink symbols, and flexible symbols. In some other examples, the TDD format may include downlink slots, uplink slots, and flexible slots (slots with full or partial flexible symbols). That is, each time unit in the enhanced TDD scheme of the present disclosure may be either a slot or symbol, or other appropriate time periods.

The slot format may be determined by a cell common UL/DL configuration, e.g. tdd-UL-DL-ConfigCommon, which is provided to the UE through system information and includes configurations of a set of DL slots/symbols, a set of UL slots/symbols and a set of flexible symbols.

FIG. 5 is a schematic diagram illustrating an example of UL/DL configuration by tdd-UL-DL-ConfigCommon in accordance with some implementations of the present disclosure. In this example, the slot format 500 for the 10 slots with 5 ms dl-ul-TransmissionPeiodicity is shown, where nrofDownlinkSlots=5 indicates that the first 5 slots are DL slots 501; nrofUplinkSlots=3 indicates that the last 3 slots are UL slots 502. The remaining OFDM symbols are flexible symbols 503.

The UE may also be provided with a UE specific RRC signalling tdd-UL-DL-ConfigDedicated, which may indicate the flexible symbols configured in tdd-UL-DL-ConfigCommon to be either UL or DL.

The UE might be provided with a UE specific, or UE group specific, DCI signalling, which carries a slot format indicator, and overrides the flexible symbols or slots.

Depending on UE capability, an NR UE in the TDD system could be configured with up to 4 pairs of bandwidth parts for DL and UL (not counting initial DL/UL BWPs). A BWP is a subset of the total cell bandwidth. Only one BWP-pair from the configured BWPs is active at any given time in a serving cell. When a UE switches from one bandwidth part to another bandwidth part, the UE needs a time gap for RF retuning. That is, the UE cannot transmit or receive during the time gap.

In the TDD system, the DL active BWP and UL active BWP are centre frequency aligned. This helps reduce DL to UL transition time. Besides, the pair of DL active BWP and the UL active BWP have the same BWP ID, and once a BWP switching indication is received, the DL active BWP and UL BWP are switched together.

It is thus desirable that frequency resources for transmission or reception in each of the TDD slots are determined, without incurring RF retuning between the different available frequency resources in different slots, and thus reducing resource wastage and power consumption.

In some examples, additional UL BWPs (i.e., a second set of BWPs) could be configured in addition to normal BWPs (i.e., a first set of BWPs). The normal BWPs refer to BWPs that are defined conventionally for data transmission before new full duplex modes are introduced. A normal BWP may include a normal UL BWP, or a normal DL BWP. The normal UL BWP may also be simply referred to as “UL BWP” in the present disclosure. Analogously, a normal DL BWP may also be referred to as “DL BWP” in the present disclosure.

Each set of BWPs contain at least one BWP. Each one of the additional UL BWPs may be associated with a UL BWP, and is configured within the frequency range of the corresponding UL BWP. The association of addition UL BWPs to UL BWPs could be 1-to-1, 1-to-many, or many-to-1, based on configuration.

For a UL active BWP (i.e., a normal UL BWP that is active), the associated additional UL BWP defines the available resources for UL transmission in the frequency domain in a specific set of slots/symbols. These specific set of slots/symbols are used for full duplex operations. Nevertheless, the UE still (RF) camps on the UL active BWP in these slots/symbols in order not to result in BWP switching delay between the UL data transmission in different slots/symbols.

In other words, the active BWP in a specific set of slots/symbols is for UE camping, but does not define available resources for UL transmission. Instead, the associated additional BWP defines such resources in these slots/symbols. As proposed, since the UE (RF) camps on the UL active BWP in the slots/symbols with the available additional BWP, the DL-to-UL transition delay between a DL slot/symbol to a consecutive slot/symbol with available additional BWP is the same as that transiting from a DL slot/symbol to a UL slot/symbol. Additionally, there is no BWP switching delay between a UL slot/symbol and a slot/symbol with additional BWP, therefore the UL transmission is not interrupted between these two kinds of slots/symbols.

The additional UL BWP may be configured using a separate RRC signalling, or it is included in the RRC signalling for the associated UL BWP. It may have a separate BWP ID, but is not counted for the maximum configurable UL BWPs for the UEs (i.e., the supported maximum number of paired BWPs for DL and UL does not take the additional BWPs into account). If the UE switches from a UL BWP to another UL BWP, the associated additional UL BWP switches correspondingly, if the associated BWPs are different for these two BWPs. The location and bandwidth of the additional BWP could be configured based on a resource indicator value with assumptions of BWP size equal to 275 RBs, and it is based on BS implementation to ensure that the additional BWP is always within the frequency range of the associated BWP.

The base station (BS) may configure separate UL channels, e.g., PUCCH, PUSCH, PRACH, and/or SRS, for the additional UL BWP.

To determine the specific slots/symbols for which the additional UL BWP applies, it is proposed to introduce TDD slot configurations to be applicable for the additional BWPs. The configurations include at least one of a cell common configuration (tdd-UL-DL-ConfigCommon-AddBWP), a UE specific RRC configuration (tdd-UL-DL-ConfigDedicated-AddBWP), and a group UE specific dynamic configuration. The TDD slot configurations for the additional BWPs may override those for the normal BWPs.

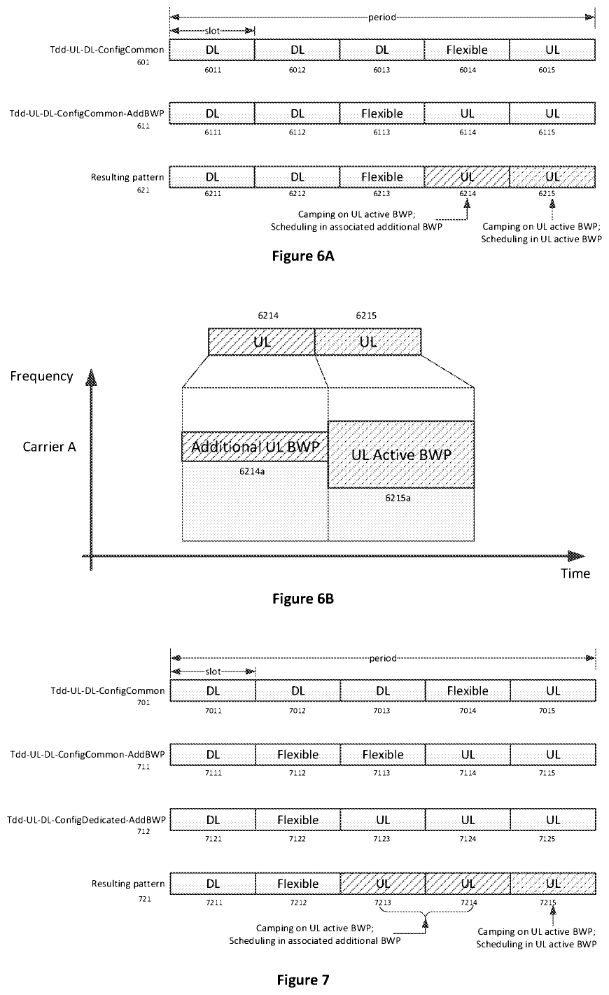

FIG. 6A is a schematic diagram illustrating an example where tdd-UL-DL-ConfigCommon-AddBWP overrides tdd-UL-DL-ConfigCommon for a DL slot and a flexible slot in accordance with some implementations of the present disclosure. As shown in FIG. 6A, a first slot pattern 601 is determined by a first set of TDD configurations, i.e., tdd-UL-DL-ConfigCommon, and applicable for all the normal BWPs. In this example, the slot pattern “DDDFU” 6011-6015 is configured. A second slot pattern 611 is configured by a second set of TDD configurations, i.e., tdd-UL-DL-ConfigCommon-AddBWP, as “DDFUU” 6111-6115. The resulting slot pattern 621 (i.e., resulting format of UL and DL transmissions) for the UEs with additional BWP is “DDFUU” 6211-6215, which is the same as the pattern configured by tdd-UL-DL-ConfigCommon-AddBWP according to an exemplary overriding rule.

The DL slot 6013 is overridden by flexible slot 6113 and may then be used for DL or UL transition in the resulting flexible slot 6213, or the flexible symbols in the slot are used for DL to UL transition.

The flexible slot 6014 is overridden by UL slot 6114, and resulting in a UL slot 6214. In the resulting UL slot 6214, the UE RF camps on the UL active BWP, and data transmission is within the associated additional BWP.

The UL slot 6015 is not affected by the UL slot 6115, and thus remains as UL slot 6215 in the resulting slot pattern. In the resulting UL slot 6215, the UE RF camps on the UL active BWP, and data transmission is also within the active BWP.

FIG. 6B is a schematic diagram illustrating an example of an associated additional UL BWP with respect to a UL active BWP for the uplink transmissions of FIG. 6A in accordance with some implementations of the present disclosure. In this example, the frequency range of the additional UL BWP 6214a for the UL slot 6214 is within the frequency range of the UL active BWP 6215a for the UL slot 6215.

Some exemplary overriding rules are proposed as follows:
a) The tdd-UL-DL-ConfigCommon-AddBWP if provided, overrides tdd-UL-DL-ConfigCommon if provided.
b) The tdd-UL-DL-ConfigDedicated-AddBWP if provided, overrides tdd-UL-DL-ConfigCommon-AddBWP if provided.
c) The dynamic slot format configuration overrides tdd-UL-DL-ConfigCommon-AddBWP or tdd-UL-DL-ConfigDedicated-AddBWP if provided.
d) If tdd-UL-DL-ConfigCommon-AddBWP is not provided, while tdd-UL-DL-ConfigDedicated-AddBWP is provided, tdd-UL-DL-ConfigDedicated-AddBWP overrides tdd-UL-DL-ConfigCommon or tdd-UL-DL-ConfigDedicated if provided.
e) If tdd-UL-DL-ConfigCommon-AddBWP and tdd-UL-DL-ConfigDedicated-AddBWP are not provided, while the dynamic indicated slot format is provided, the dynamic indicated slot format overrides tdd-UL-DL-ConfigCommon and tdd-UL-DL-ConfigDedicated if provided.

Some exemplary application principles for applying the overriding rules are proposed as follows:
i. In some examples, the overriding rules apply only to the flexible slots/symbols configured by tdd-UL-DL-ConfigCommon or tdd-UL-DL-ConfigDedicated if provided. If the flexible slots/symbols are indicated as UL by the TDD configurations for the additional BWP, the additional BWP applies for these slots/symbols.
ii. In some other examples, the overriding rules apply to both flexible slots/symbols and non-flexible slots/symbols. If a flexible slot/symbol or a DL slot/symbol are indicated as UL by the TDD configurations for the additional BWP, the additional BWP applies for these slots/symbols. If a flexible slot/symbol or a DL slot/symbol are indicated as flexible by the TDD configurations for the additional BWP, the additional BWP may apply to these slots/symbols if UE receives a UL grant for such slots/symbols.
iii. In some further examples, the UE will not perform overriding if a UL slot/symbol configured by tdd-UL-DL-ConfigCommon or tdd-UL-DL-ConfigDedicated is indicated as DL by TDD configurations for the additional BWP.
iv. In some further examples, the UE will not perform overriding if a UL slot/symbol configured by tdd-UL-DL-ConfigCommon or tdd-UL-DL-ConfigDedicated is indicated as flexible by TDD configurations for the additional BWP. While in some other examples, the UE will perform the overriding.
v. In some yet further examples, to which slots/symbols the overriding applies may be configured by the base station (BS).

In some examples, a capability reporting may be provided by the UE to the base station (BS). The BS may determine some adjusted overriding rules and/or application principles based on the capability reporting. For example, a UE may report that it supports additional BWPs, and accordingly the BS can configure additional BWPs for the UE. The overriding rules can be applied to this UE. Otherwise, the BS will not configure the additional BWPs for the UE. In some further examples, the UE may report it is capable of being configured with more than one TDD UL and DL configurations with one slot format configuration overriding the non-flexible slots/symbols from another configuration. The overriding rules can be applied to this UE.

In application of the above overriding rules and/or application principles, more detailed UE behaviour of some examples on determination of DL and UL resources are illustrated as follows.

The UE considers slots, or symbols in a slot, as downlink to be available for reception in all the normal DL BWPs if they are indicated as downlink by tdd-UL-DL-ConfigCommm, or tdd-UL-DL-ConfigDedicated if provided, and by tdd-UL-DL-ConfigCommon-AddBWP or by tdd-UL-DL-ConfigDedicated-AddBWP if provided.

The UE considers slots, or symbols in a slot, as uplink to be available for transmission in all the normal UL BWPs if they are indicated as uplink by tdd-UL-DL-ConfigCommm, or tdd-UL-DL-ConfigDedicated if provided, and by tdd-UL-DL-ConfigCommon-AddBWP or by tdd-UL-DL-ConfigDedicated-AddBWP if provided.

The UE considers slots, or symbols in a slot, as uplink to be available for transmission in the additional UL BWPs that is associated with the normal UL BWPs if they are indicated as uplink by tdd-UL-DL-ConfigCommon-AddBWP or by tdd-UL-DL-ConfigDedicated-AddBWP, while indicated as flexible by tdd-UL-DL-ConfigCommon or by tdd-UL-DL-ConfigDedicated.

The UE considers slots, or symbols in a slot, as uplink to be available for transmission in the additional UL BWPs that is associated with the normal UL BWPs if they are indicated as uplink by tdd-UL-DL-ConfigCommon-AddBWP or by tdd-UL-DL-ConfigDedicated-AddBWP, while indicated as DL by tdd-UL-DL-ConfigCommon or by tdd-UL-DL-ConfigDedicated.

For a set of symbols that are indicated as flexible by tdd-UL-DL-ConfigCommon-AddBWP or tdd-UL-DL-ConfigDedicated-AddBWP, while are indicated as downlink by tdd-UL-DL-ConfigCommon or tdd-UL-DL-ConfigDedicated, the UE transmits PUSCH, PUCCH, PRACH or SRS in these symbols in the additional BWP that is associated with the UL active BWP if the UE receives a corresponding indication.

For a set of symbols that are indicated as flexible by tdd-UL-DL-ConfigCommon-AddBWP or tdd-UL-DL-ConfigDedicated-AddBWP, while are indicated as UL by tdd-UL-DL-ConfigCommon or tdd-UL-DL-ConfigDedicated, the UE transmits PUSCH, PUCCH, PRACH or SRS in these symbols in the additional BWP of the associated UL active BWP if the UE receives a corresponding indication.

For a set of symbols that are indicated as flexible by tdd-UL-DL-ConfigCommon-AddBWP or tdd-UL-DL-ConfigDedicated-AddBWP, while are indicated as flexible or UL by tdd-UL-DL-ConfigCommon or tdd-UL-DL-ConfigDedicated, the UE transmits PUSCH, PUCCH, PRACH or SRS in the additional BWP associated with the UL active BWP if the UE receives a corresponding indication in one example. In another example, the UE transmits PUSCH, PUCCH, PRACH or SRS in these symbols in the UL active BWP if the UE receives a corresponding indication. In a yet further example, in which BWP the UE transmits the UL signals is based BS configuration.

For a set of symbols that are indicated as flexible by tdd-UL-DL-ConfigCommon or tdd-UL-DL-ConfigDedicated, and indicated as UL by a dynamic slot format indication, the UE transmits PUSCH, PUCCH, PRACH or SRS in these symbols in the additional BWP of the associated UL active BWP if the UE receives a corresponding indication.

For a set of symbols that are indicated as DL by tdd-UL-DL-ConfigCommon or tdd-UL-DL-ConfigDedicated, and indicated as UL by a dynamic slot format indication, the UE transmits PUSCH, PUCCH, PRACH or SRS in these symbols in the additional BWP of the associated UL active BWP if the UE receives a corresponding indication.

For a set of symbols that are indicated as flexible by tdd-UL-DL-ConfigCommon-AddBWP or tdd-UL-DL-ConfigDedicated-AddBWP, and indicated as UL by a dynamic slot format indication, the UE transmits PUSCH, PUCCH, PRACH or SRS in these symbols in the additional BWP of the associated UL active BWP if the UE receives a corresponding indication.

In one example, the dynamic slot format indication is carried in a DCI that is scrambled with a specific Radio Network Temporary Identity (RNTI), differentiate with the one used for existing non-full duplex usage. The RNTI is configured using a RRC signalling. The DCI is defined for a single UE or a group of UEs for full duplex usage.

FIG. 7 is a schematic diagram illustrating an example where tdd-UL-DL-ConfigCommon-AddBWP overrides tdd-UL-DL-ConfigCommon for two DL slots and a flexible slot, and tdd-UL-DL-ConfigDedicated-AddBWP overrides tdd-UL-DL-ConfigCommon-AddBWP for one flexible slot, in accordance with some implementations of the present disclosure. In this example, a cell level slot pattern 701 is determined by tdd-UL-DL-ConfigCommon and applicable to all the normal BWPs, i.e., “DDDFU” 7011-7015 is configured. Another cell level slot pattern 711 is configured by tdd-UL-DL-ConfigCommon-AddBWP as “DFFUU” 7111-7115. The resulting cell level slot pattern for UEs with additional BWP is therefore “DFFUU”.

A UE specific slot pattern 712 “DFUUU” 7121-7125 is provided by tdd-UL-DL-ConfigDedicated-AddBWP and overrides one flexible slot 7113 as UL slot 7213 in the resulting cell level slot pattern 721. As a result, in the two UL slots 7213 and 7214, the UE (RF) camps on the UL active BWP but the data transmission is within the associated additional BWP. In the resulting UL slot 7215, the UE RF camps on the UL active BWP, and data transmission is also within the active BWP.

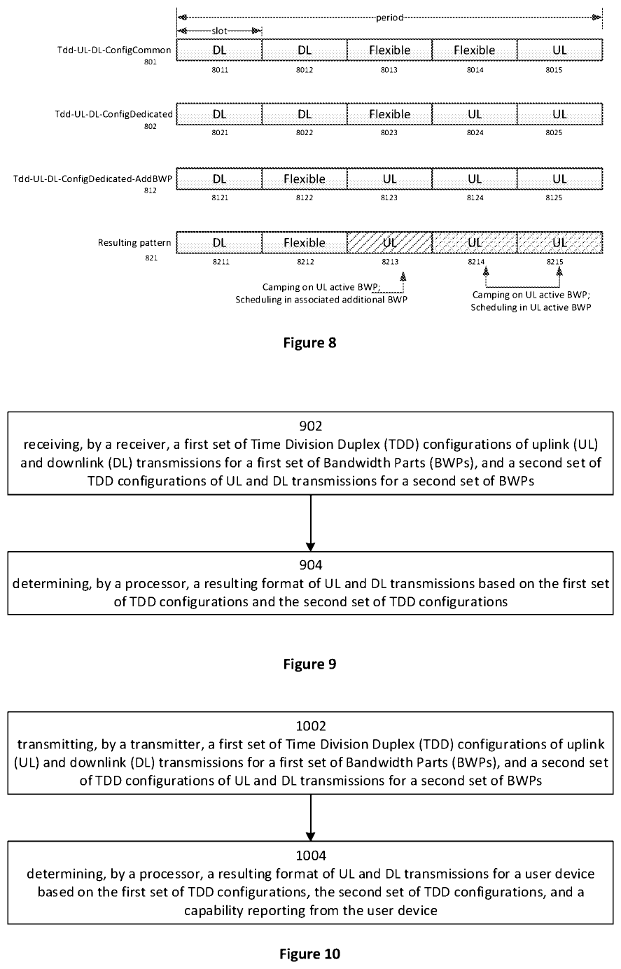

FIG. 8 is a schematic diagram illustrating an example where tdd-UL-DL-ConfigDedicated-AddBWP overrides tdd-UL-DL-ConfigDedicated for one DL slot and one flexible slot in accordance with some implementations of the present disclosure. In this example, a cell level slot pattern 801 is determined by tdd-UL-DL-ConfigCommon and applicable for all the normal BWPs, i.e., “DDFFU” 8011-8015 is configured. A UE specific slot pattern 802 is configured by tdd-UL-DL-ConfigDedicated as “DDFUU” 8021-8025. The resulting UE specific slot pattern for normal BWPs is therefore “DDFUU”.

A UE specific slot pattern 812 “DFUUU” 8121-8125 is provided by tdd-UL-DL-ConfigDedicated-AddBWP, and overrides one DL slot 8022 as flexible slot 8212 and one flexible slot 8023 as UL slot 8213 in the resulting UE specific slot pattern 821. As a result, in the UL slot 8213, the UE (RF) camps on the UL active BWP but the data transmission is within the associated additional BWP. In the resulting UL slots 8214 and 8215, the UE RF camps on the UL active BWP, and the data transmission is also within the active BWP.

In some examples, there are no additional BWPs, i.e., the BWPs in the first set and the second set are the same. Additional TDD configurations including at least one of a cell common configuration (tdd-UL-DL-ConfigCommon-AddBWP), a UE specific RRC configuration (tdd-UL-DL-ConfigDedicated-AddBWP), and a group UE specific dynamic configuration are configured for the normal BWPs. And such TDD configurations could override the existing TDD configurations (i.e., tdd-UL-DL-ConfigCommon, tdd-UL-DL-ConfigDedicated) following the same principles as defined above.

FIG. 9 is a flow chart illustrating steps of determining format of uplink and downlink transmissions for full duplex time division duplex by UE 200 in accordance with some implementations of the present disclosure.

At step 902, the receiver 214 of UE 200 receives a first set of Time Division Duplex (TDD) configurations of uplink (UL) and downlink (DL) transmissions for a first set of Bandwidth Parts (BWPs), and a second set of TDD configurations of UL and DL transmissions for a second set of BWPs.

At step 904, the processor 202 of UE 200 determines a resulting format of UL and DL transmissions based on the first set of TDD configurations and the second set of TDD configurations.

FIG. 10 is a flow chart illustrating steps of determining format of uplink and downlink transmissions for full duplex time division duplex by gNB or NE 300 in accordance with some implementations of the present disclosure.

At step 1002, the transmitter 312 of NE 300 transmits a first set of Time Division Duplex (TDD) configurations of uplink (UL) and downlink (DL) transmissions for a first set of Bandwidth Parts (BWPs), and a second set of TDD configurations of UL and DL transmissions for a second set of BWPs.

At step 1004, the processor 302 of NE 300 determines a resulting format of UL and DL transmissions for a user device based on the first set of TDD configurations, the second set of TDD configurations, and a capability reporting from the user device.

In one aspect, some items as examples of the disclosure concerning a method of a UE or remote device may be summarized as follows:
1. A method, comprising:
receiving, by a receiver, a first set of Time Division Duplex (TDD) configurations of uplink (UL) and downlink (DL) transmissions for a first set of Bandwidth Parts (BWPs), and a second set of TDD configurations of UL and DL transmissions for a second set of BWPs; and
determining, by a processor, a resulting format of UL and DL transmissions based on the first set of TDD configurations and the second set of TDD configurations.
2. The method of item 1, wherein the first set of BWPs and the second set of BWPs are same set of BWPs.
3. The method of item 1, wherein the second set of BWPs comprise additional BWPs, each one of the additional BWPs being associated with a BWP in the first set of BWPs.
4. The method of item 1, wherein the resulting format comprises a format for each time unit of slot or symbol, which is either a downlink time unit, uplink time unit or a flexible time unit.
5. The method of item 1, wherein the resulting format comprises a corresponding BWP for each time unit of slot or symbol based on the first and second sets of TDD configurations, which comprise either an active BWP from the first set of BWPs, or a BWP from the second set of BWPs.
6. The method of item 1, wherein the first set of TDD configurations comprise at least one selected from: a first cell common configuration, a first User Equipment (UE) specific Radio Resource Control (RRC) configuration, and a first UE specific physical layer (PHY) configuration; and the second set of TDD configurations comprise at least one selected from: a second cell common configuration, a second UE specific RRC configuration, and a second UE specific PHY configuration.
7. The method of item 3, wherein each additional BWP in the second set of BWPs is configured within a frequency range of the associated BWP in the first set of BWPs.
8. The method of item 1, wherein a configuration of each of the BWPs in the second set of BWPs comprises a configuration for at least one selected from: Physical Uplink Control Channel (PUCCH), Physical Uplink Shared Channel (PUSCH), Physical Random Access Channel (PRACH), Sounding Reference Signal (SRS).
9. The method of item 1, wherein a TDD configuration of UL and DL transmissions from the second set of TDD configurations overrides a TDD configuration of UL and DL transmissions from the first set of TDD configurations.
10. The method of item 9, wherein the overriding applies for the flexible symbols configured by the TDD configuration of UL and DL transmissions from the first set of TDD configurations.
11. The method of item 10, wherein a flexible symbol is overridden as a UL symbol, and the method further comprises transmitting in the BWP from the second set of BWPs that is associated with an active BWP in the UL symbol.
12. The method of item 9, wherein the overriding applies for both the flexible and non-flexible symbols configured by the TDD configuration of UL and DL transmissions from the first set of TDD configurations, including DL symbols.
13. The method of item 12, wherein a flexible symbol or a DL symbol is overridden by a UL symbol, and the method further comprises transmitting in a BWP from the second set of BWPs that is associated with an active BWP in the UL symbol.
14. The method of item 13, wherein a flexible symbol or a DL symbol is overridden by a flexible symbol, and the method further comprises transmitting in a BWP from the second set of BWPs that is associated with an active BWP in the UL symbol based on a UL grant.
15. The method of item 9, wherein the overriding of UL symbols configured by the TDD configuration of UL and DL transmissions from the first set of TDD configurations is not allowable.

In another aspect, some items as examples of the disclosure concerning a method of a NE or gNB may be summarized as follows:
16. A method, comprising:
transmitting, by a transmitter, a first set of Time Division Duplex (TDD) configurations of uplink (UL) and downlink (DL) transmissions for a first set of Bandwidth Parts (BWPs), and a second set of TDD configurations of UL and DL transmissions for a second set of BWPs; and
determining, by a processor, a resulting format of UL and DL transmissions for a user device based on the first set of TDD configurations, the second set of TDD configurations, and a capability reporting from the user device.
17. The method of item 16, wherein the first set of BWPs and the second set of BWPs are same set of BWPs.
18. The method of item 16, wherein the second set of BWPs comprise additional BWPs, each one of the additional BWPs being associated with a BWP in the first set of BWPs.
19. The method of item 16, wherein the resulting format comprises a format for each time unit of slot or symbol, which is either a downlink time unit, uplink time unit or a flexible time unit.
20. The method of item 16, wherein the resulting format comprises a corresponding BWP for each time unit of slot or symbol based on the first and second sets of TDD configurations, which comprise either an active BWP from the first set of BWPs, or a BWP from the second set of BWPs.
21. The method of item 16, wherein the first set of TDD configurations comprise at least one selected from: a first cell common configuration, a first User Equipment (UE) specific Radio Resource Control (RRC) configuration, and a first UE specific physical layer (PHY) configuration; and the second set of TDD configurations comprise at least one selected from: a second cell common configuration, a second UE specific RRC configuration, and a second UE specific PHY configuration.
22. The method of item 18, wherein each additional BWP in the second set of BWPs is configured within a frequency range of the associated BWP in the first set of BWPs.
23. The method of item 16, wherein a configuration of each of the BWPs in the second set of BWPs comprises a configuration for at least one selected from: Physical Uplink Control Channel (PUCCH), Physical Uplink Shared Channel (PUSCH), Physical Random Access Channel (PRACH), Sounding Reference Signal (SRS).
24. The method of item 16, wherein a TDD configuration of UL and DL transmissions from the second set of TDD configurations overrides a TDD configuration of UL and DL transmissions from the first set of TDD configurations.
25. The method of item 24, wherein the overriding applies for the flexible symbols configured by the TDD configuration of UL and DL transmissions from the first set of TDD configurations.
26. The method of item 25, wherein a flexible symbol is overridden as a UL symbol, and the method further comprises receiving in the BWP from the second set of BWPs that is associated with an active BWP in the UL symbol.
27. The method of item 24, wherein the overriding applies for both the flexible and non-flexible symbols configured by the TDD configuration of UL and DL transmissions from the first set of TDD configurations, including DL symbols.
28. The method of item 27, wherein a flexible symbol or a DL symbol is overridden by a UL symbol, the method further comprises receiving in a BWP from the second set of BWPs that is associated with an active BWP in the UL symbol.
29. The method of item 28, wherein a flexible symbol or a DL symbol is overridden by a flexible symbol, the method further comprises receiving in a BWP from the second set of BWPs that is associated with an active BWP in the UL symbol based on a UL grant.
30. The method of item 24, wherein the overriding of UL symbols configured by the TDD configuration of UL and DL transmissions from the first set of TDD configurations is not allowable.

In a further aspect, some items as examples of the disclosure concerning a UE or remote device may be summarized as follows:
31. An apparatus, comprising:
a receiver that receives a first set of Time Division Duplex (TDD) configurations of uplink (UL) and downlink (DL) transmissions for a first set of Bandwidth Parts (BWPs), and a second set of TDD configurations of UL and DL transmissions for a second set of BWPs; and
a processor that determines a resulting format of UL and DL transmissions based on the first set of TDD configurations and the second set of TDD configurations.
32. The apparatus of item 31, wherein the first set of BWPs and the second set of BWPs are same set of BWPs.
33. The apparatus of item 31, wherein the second set of BWPs comprise additional BWPs, each one of the additional BWPs being associated with a BWP in the first set of BWPs.
34. The apparatus of item 31, wherein the resulting format comprises a format for each time unit of slot or symbol, which is either a downlink time unit, uplink time unit or a flexible time unit.
35. The apparatus of item 31, wherein the resulting format comprises a corresponding BWP for each time unit of slot or symbol based on the first and second sets of TDD configurations, which comprise either an active BWP from the first set of BWPs, or a BWP from the second set of BWPs.
36. The apparatus of item 31, wherein the first set of TDD configurations comprise at least one selected from: a first cell common configuration, a first User Equipment (UE) specific Radio Resource Control (RRC) configuration, and a first UE specific physical layer (PHY) configuration; and the second set of TDD configurations comprise at least one selected from: a second cell common configuration, a second UE specific RRC configuration, and a second UE specific PHY configuration.
37. The apparatus of item 33, wherein each additional BWP in the second set of BWPs is configured within a frequency range of the associated BWP in the first set of BWPs.
38. The apparatus of item 31, wherein a configuration of each of the BWPs in the second set of BWPs comprises a configuration for at least one selected from: Physical Uplink Control Channel (PUCCH), Physical Uplink Shared Channel (PUSCH), Physical Random Access Channel (PRACH), Sounding Reference Signal (SRS).
39. The apparatus of item 31, wherein a TDD configuration of UL and DL transmissions from the second set of TDD configurations overrides a TDD configuration of UL and DL transmissions from the first set of TDD configurations.
40. The apparatus of item 39, wherein the overriding applies for the flexible symbols configured by the TDD configuration of UL and DL transmissions from the first set of TDD configurations.
41. The apparatus of item 40, wherein a flexible symbol is overridden as a UL symbol, and the apparatus further comprises a transmitter that transmits in the BWP from the second set of BWPs that is associated with an active BWP in the UL symbol.
42. The apparatus of item 39, wherein the overriding applies for both the flexible and non-flexible symbols configured by the TDD configuration of UL and DL transmissions from the first set of TDD configurations, including DL symbols.
43. The apparatus of item 42, wherein a flexible symbol or a DL symbol is overridden by a UL symbol, and the apparatus further comprises a transmitter that transmits in a BWP from the second set of BWPs that is associated with an active BWP in the UL symbol.
44. The apparatus of item 43, wherein a flexible symbol or a DL symbol is overridden by a flexible symbol, and the apparatus further comprises a transmitter that transmits in a BWP from the second set of BWPs that is associated with an active BWP in the UL symbol based on a UL grant.
45. The apparatus of item 39, wherein the overriding of UL symbols configured by the TDD configuration of UL and DL transmissions from the first set of TDD configurations is not allowable.

In a yet further aspect, some items as examples of the disclosure concerning a NE or gNB may be summarized as follows:
46. An apparatus, comprising:
a transmitter that transmits a first set of Time Division Duplex (TDD) configurations of uplink (UL) and downlink (DL) transmissions for a first set of Bandwidth Parts (BWPs), and a second set of TDD configurations of UL and DL transmissions for a second set of BWPs; and
a processor that determines a resulting format of UL and DL transmissions for a user device based on the first set of TDD configurations, the second set of TDD configurations, and a capability reporting from the user device.
47. The apparatus of item 46, wherein the first set of BWPs and the second set of BWPs are same set of BWPs.
48. The apparatus of item 46, wherein the second set of BWPs comprise additional BWPs, each one of the additional BWPs being associated with a BWP in the first set of BWPs.
49. The apparatus of item 46, wherein the resulting format comprises a format for each time unit of slot or symbol, which is either a downlink time unit, uplink time unit or a flexible time unit.
50. The apparatus of item 46, wherein the resulting format comprises a corresponding BWP for each time unit of slot or symbol based on the first and second sets of TDD configurations, which comprise either an active BWP from the first set of BWPs, or a BWP from the second set of BWPs.
51. The apparatus of item 46, wherein the first set of TDD configurations comprise at least one selected from: a first cell common configuration, a first User Equipment (UE) specific Radio Resource Control (RRC) configuration, and a first UE specific physical layer (PHY) configuration; and the second set of TDD configurations comprise at least one selected from: a second cell common configuration, a second UE specific RRC configuration, and a second UE specific PHY configuration.
52. The apparatus of item 48, wherein each additional BWP in the second set of BWPs is configured within a frequency range of the associated BWP in the first set of BWPs.
53. The apparatus of item 46, wherein a configuration of each of the BWPs in the second set of BWPs comprises a configuration for at least one selected from: Physical Uplink Control Channel (PUCCH), Physical Uplink Shared Channel (PUSCH), Physical Random Access Channel (PRACH), Sounding Reference Signal (SRS).
54. The apparatus of item 46, wherein a TDD configuration of UL and DL transmissions from the second set of TDD configurations overrides a TDD configuration of UL and DL transmissions from the first set of TDD configurations.
55. The apparatus of item 54, wherein the overriding applies for the flexible symbols configured by the TDD configuration of UL and DL transmissions from the first set of TDD configurations.
56. The apparatus of item 55, wherein a flexible symbol is overridden as a UL symbol, and the apparatus further comprises a receiver that receives in the BWP from the second set of BWPs that is associated with an active BWP in the UL symbol.
57. The apparatus of item 54, wherein the overriding applies for both the flexible and non-flexible symbols configured by the TDD configuration of UL and DL transmissions from the first set of TDD configurations, including DL symbols.
58. The apparatus of item 57, wherein a flexible symbol or a DL symbol is overridden by a UL symbol, and the apparatus further comprises a receiver that receives in a BWP from the second set of BWPs that is associated with an active BWP in the UL symbol.
59. The apparatus of item 58, wherein a flexible symbol or a DL symbol is overridden by a flexible symbol, and the apparatus further comprises a receiver that receives in a BWP from the second set of BWPs that is associated with an active BWP in the UL symbol based on a UL grant.
60. The apparatus of item 54, wherein the overriding of UL symbols configured by the TDD configuration of UL and DL transmissions from the first set of TDD configurations is not allowable.

Various embodiments and/or examples are disclosed to provide exemplary and explanatory information to enable a person of ordinary skill in the art to put the disclosure into practice. Features or components disclosed with reference to one embodiment or example are also applicable to all embodiments or examples unless specifically indicated otherwise.

Embodiments may be practiced in other specific forms. The described embodiments are to be considered in all respects only as illustrative and not restrictive. The scope is, therefore, indicated by the appended claims rather than by the foregoing description. All changes which come within the meaning and range of equivalency of the claims are to be embraced within their scope.

What is claimed is:

1. A user equipment (UE) for wireless communication, comprising:
at least one memory; and
at least one processor coupled with the at least one memory and configured to cause the UE to:
receive a first set of Time Division Duplex (TDD) configurations of uplink (UL) and downlink (DL) transmissions for a first set of Bandwidth Parts (BWPs), and a second set of TDD configurations of UL and DL transmissions for a second set of BWPs; and
determine a resulting format of UL and DL transmissions based on the first set of TDD configurations and the second set of TDD configurations.

2. The UE of claim 1, wherein the first set of BWPs and the second set of BWPs are a same set of BWPs.

3. The UE method of claim 1, wherein the second set of BWPs comprise additional BWPs, each one of the additional BWPs being associated with a BWP in the first set of BWPs.

4. The UE of claim 1, wherein the resulting format comprises a format for each time unit of slot or symbol, the format for each time unit of slot or symbol comprising a downlink time unit, uplink time unit, or a flexible time unit.

5. The UE of claim 1, wherein the resulting format comprises a corresponding BWP for each time unit of slot or symbol based on the first and second sets of TDD configurations, the corresponding BWP for each time unit of slot or symbol comprising an active BWP from the first set of BWPs or a BWP from the second set of BWPs.

6. The UE of claim 1, wherein:
the first set of TDD configurations comprises at least one of a first cell common configuration, a first UE specific Radio Resource Control (RRC) configuration, or a first UE specific physical layer (PHY) configuration; and
the second set of TDD configurations comprises at least one of a second cell common configuration, a second UE specific RRC configuration, or a second UE specific PHY configuration.

7. The UE of claim 3, wherein each additional BWP in the second set of BWPs is configured within a frequency range of the associated BWP in the first set of BWPs.

8. The UE of claim 1, wherein a TDD configuration of UL and DL transmissions from the second set of TDD configurations overrides a TDD configuration of UL and DL transmissions from the first set of TDD configurations.

9. The UE of claim 8, wherein overriding applies for flexible symbols configured by the TDD configuration of UL and DL transmissions from the first set of TDD configurations.

10. The UE of claim 9, wherein a flexible symbol is overridden as a UL symbol, and the at least one processor is configured to cause the UE to transmit in a BWP from the second set of BWPs that is associated with an active BWP in the UL symbol.

11. The UE of claim 8, wherein overriding applies for both flexible and non-flexible symbols configured by the TDD configuration of UL and DL transmissions from the first set of TDD configurations, including DL symbols.

12. The UE of claim 11, wherein a flexible symbol or a DL symbol is overridden by a UL symbol, and the at least one processor is configured to cause the UE to transmit in a BWP from the second set of BWPs that is associated with an active BWP in the UL symbol.

13. The UE of claim 12, wherein a flexible symbol or a DL symbol is overridden by a flexible symbol, and the at least one processor is configured to cause the UE to transmit in a BWP from the second set of BWPs that is associated with an active BWP in the UL symbol based on a UL grant.

14. The UE of claim 8, wherein overriding of UL symbols configured by the TDD configuration of UL and DL transmissions from the first set of TDD configurations is not allowable.

15. A network equipment for wireless communication, comprising:
at least one memory; and
at least one processor coupled with the at least one memory and configured to cause the network equipment to:
transmit a first set of Time Division Duplex (TDD) configurations of uplink (UL) and downlink (DL) transmissions for a first set of Bandwidth Parts (BWPs), and a second set of TDD configurations of UL and DL transmissions for a second set of BWPs; and
determine a resulting format of UL and DL transmissions for a user device based on the first set of TDD configurations, the second set of TDD configurations, and a capability reporting from the user device.

16. A processor for wireless communication, comprising:
at least one controller coupled with at least one memory and configured to cause the processor to:
receive a first set of Time Division Duplex (TDD) configurations of uplink (UL) and downlink (DL) transmissions for a first set of Bandwidth Parts (BWPs), and a second set of TDD configurations of UL and DL transmissions for a second set of BWPs; and
determine a resulting format of UL and DL transmissions based on the first set of TDD configurations and the second set of TDD configurations.

17. The processor of claim 16, wherein the first set of BWPs and the second set of BWPs are same set of BWPs.

18. The processor of claim 16, wherein the second set of BWPs comprise additional BWPs, each one of the additional BWPs being associated with a BWP in the first set of BWPs.

19. The processor of claim 16, wherein the resulting format comprises a format for each time unit of slot or symbol, which is either a downlink time unit, uplink time unit or a flexible time unit.

20. A method performed by a user equipment (UE), the method comprising:
receiving a first set of Time Division Duplex (TDD) configurations of uplink (UL) and downlink (DL) transmissions for a first set of Bandwidth Parts (BWPs), and a second set of TDD configurations of UL and DL transmissions for a second set of BWPs; and
determining a resulting format of UL and DL transmissions based on the first set of TDD configurations and the second set of TDD configurations.
